(19) United States
(12) Patent Application Publication
(10) Pub. No.: US 2025/0371521 A1
(43) Pub. Date: Dec. 4, 2025

(54) TOKENIZING PAYMENT CARDS IN A MOBILE APPLICATION EXPERIENCE

(71) Applicants: American Express Travel Related Services Company, Inc., New York, NY (US); American Express Services Europe Limited, London (GB)

(72) Inventors: Gemma Beck, London (GB); Micaela Esposito, Sandown (GB); Ajay Babu Maddukuri, Phoenix, AZ (US); George Kenneth McLeod, London (GB); Dhanya Prasannakumari Govinda Pillai, Burgess Hill (GB)

(21) Appl. No.: 18/678,695

(22) Filed: May 30, 2024

(51) Int. Cl. G06Q 20/34; G06Q 30/0601

(52) U.S. Cl. CPC G06Q 20/341; G06Q 20/36; G06Q 20/3821; G06Q 30/0641

(57) ABSTRACT

Examples herein can receive facilitate transactions between a user and a merchant computing environment by rendering merchant content within a web view component. A checkout user interface element can be detected within the web view component. A tokenized form of a payment card can be generated and populated within the checkout user interface element without user intervention.

### BACKGROUND

Acquisition of customers on mobile devices and on the Internet can be a difficult and expensive process. To acquire customers, they typically must go through some form of a customer acquisition funnel that involves making the users aware of a brand, education of the user about the brand, inspiration of the user regarding the brand and regarding products offered by the brand, and then allowing the user to efficiently navigate product and checkout pages.

Traditional ways of doing e-commerce can be cumbersome. For example, employing search optimization processes so that users organically arrive at a brand's website can be an effective way to acquire customers, but the payment flow is often disconnected and inconvenient for the user. A high percentage of users might abandon a site or abandon a shopping cart because there is too much friction in the product discovery and buying process.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing of a network environment according to various embodiments of the present disclosure.

FIG. 2 is an example user interface according to various examples of the disclosure illustrating functionality in the network environment of FIG. 1.

FIG. 3 is an example user interface according to various examples of the disclosure illustrating functionality in the network environment of FIG. 1.

FIG. 4 is an example user interface according to various examples of the disclosure illustrating functionality in the network environment of FIG. 1.

FIG. 5 is an example user interface according to various examples of the disclosure illustrating functionality in the network environment of FIG. 1.

FIG. 6 is a flowchart according to various examples of the disclosure illustrating functionality in the network environment of FIG. 1.

### DETAILED DESCRIPTION

Disclosed are various approaches for providing an efficient customer acquisition funnel in a mobile application. The customer acquisition funnel can allow for brands to acquire customers while removing many of the impediments for customer acquisition that users often face, such as brand discovery, product inspiration, selecting a payment card, completing a payment flow, complete a checkout user interface. In general, a credit card payment transaction in an online context involves presenting a payment instrument such as a credit card to a checkout user interface. Brands often have difficulty acquiring customers without the aid of retailers because customers often discover brands and products of a brand through retailers.

For example, users might have a need or desire for a particular product category. Users might default to discovering brands and products through a retailer, which may present only certain brands and products to the user. Examples of the disclosure provide a more efficient customer acquisition funnel through a mobile application or website provided by a payment card issuer, which can allow brands to educate and inspire potential customers and can also allow for the payment card issuer to facilitate completing of a transaction because a shopping experience can be conducted inside of a protected user experience provided by the payment card issuer.

Examples of the disclosure also provide a technical solution to the challenge of securely facilitating transactions between users and merchants. Existing solutions often involve the use of a virtual card number that can be generated on behalf of a user. However, virtual cards are often generated and utilized outside of a customer acquisition funnel, requiring the user to copy and paste a virtual card number into a checkout user interface, which can be a cumbersome user experience. Examples of the disclosure can automatically generate and utilize tokens to facilitate transactions between users and a merchant site. By automatically utilizing tokens associated with a payment card of the user, the user's actual payment card details can be obfuscated from a given merchant without requiring the user to generate and insert a virtual card number, which can be a manual and cumbersome process.

In the following discussion, a general description of the system and its components is provided, followed by a discussion of the operation of the same. Although the following discussion provides illustrative examples of the operation of various components of the present disclosure, the use of the following illustrative examples does not exclude other implementations that are consistent with the principals disclosed by the following illustrative examples.

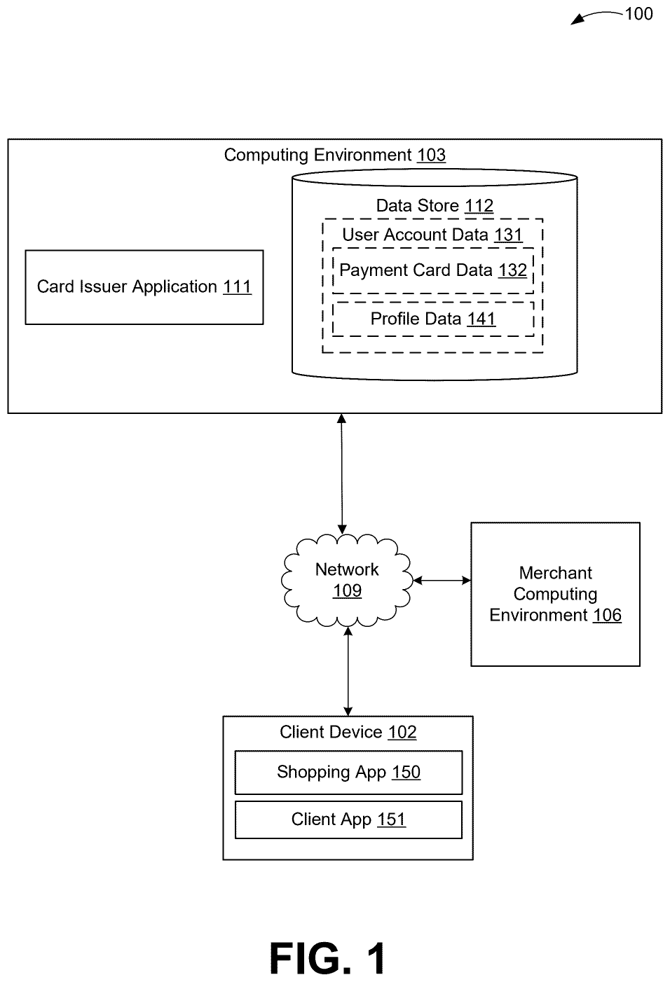

With reference to FIG. 1, shown is a network environment 100 according to various embodiments. The network environment 100 can include one or more client devices 102, a computing environment 103, and a merchant computing environment 106, which can be in data communication with each other via a network 109.

The network 109 can include wide area networks (WANs), local area networks (LANs), personal area networks (PANs), or a combination thereof. These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (i.e., WI-FI®), BLUETOOTH® networks, microwave transmission networks, as well as other networks relying on radio broadcasts. The network 109 can also include a combination of two or more networks 115. Examples of networks 115 can include the Internet, intranets, extranets, virtual private networks (VPNs), and similar networks.

In various examples, the network 109 can include a payment network for facilitating a processing of a payment. The payment network can include an open network or a closed loop network. The open network may be a network that is accessible by various third parties and/or a network in which banking systems from different entities interact. Alternatively, the network 109 can also be a closed loop network. For example, the closed loop network can include issuer bank systems and acquiring bank systems, in which third parties can be restricted from accessing the closed loop network. For instance, a single financial entity can have the issuing banking systems and the acquiring banking systems in a single payment network. In this scenario, the single financial entity has payment data related to the payment accounts for individual users and the payment processing data related to merchant accounts and/or owed balance operators.

The computing environment 103 can include one or more computing devices that include a processor, a memory, and/or a network interface. For example, the computing devices can be configured to perform computations on behalf of other computing devices or applications. As another example, such computing devices can host and/or provide content to other computing devices in response to requests for content.

Moreover, the computing environment 103 can employ a plurality of computing devices that can be arranged in one or more server banks or computer banks or other arrangements. Such computing devices can be located in a single installation or can be distributed among many different geographical locations. For example, the computing environment 103 can include a plurality of computing devices that together can include a hosted computing resource, a grid computing resource or any other distributed computing arrangement. In some cases, the computing environment 103 can correspond to an elastic computing resource where the allotted capacity of processing, network, storage, or other computing-related resources can vary over time.

Various applications or other functionality can be executed in the computing environment 103. The components executed on the computing environment 103 include the card issuer application 111, and other applications, services, processes, systems, engines, or functionality not discussed in detail herein. The card issuer application 111 can be executed to provide user information, such as card details, a name, shipping address, billing address, phone number, etc., about a user to a shopping application 150 that is executed on a client device 102. In some implementations, the card issuer application 111 can generate and provide a tokenized form of a payment card associated with a user account to the shopping application 150 for so that a user can utilize a tokenized card number to make purchases via the shopping application 150.

Also, various data is stored in a data store 112 that is accessible to the computing environment 103. The data store 112 can be representative of a plurality of data stores 112, which can include relational databases or non-relational databases such as object-oriented databases, hierarchical databases, hash tables or similar key-value data stores, as well as other data storage applications or data structures. Moreover, combinations of these databases, data storage applications, and/or data structures may be used together to provide a single, logical, data store. The data stored in the data store 112 is associated with the operation of the various applications or functional entities described below. This data can include user account data 131 and potentially other data.

The user account data 131 can correspond to a financial account associated with a user and provided and managed by the entity associated with the computing environment 103. The user account data 131 can include an account holder name, an account holder address, an account number, a card number, an account balance, an account transaction ledger, and/or other data. The user account data 131 can further include information from which the card issuer application 111 can make a determination to approve or deny a card payment request received from a POS device 109 on behalf of a user.

For example, the user account data 131 can comprise payment card data 132 and profile data 141. Payment card data 132 can include a payment card number, spending limits, funds availability, and other information about a particular payment card, such as a credit card, charge card, stored-value card (e.g., prepaid or gift card), or debit card, that is associated with a user account. The spending limits can specify how much spending is permitted in a given time period that a particular user account or a card associated with a user account. Funds availability can specify how much funds are associated with a user account, which can also help define how much spending is permitted for a given user account or a card associated with a user account. Payment card data 132 can also comprise a card number, one or more tokenized card numbers, which respectively represent a tokenized form of a card number. A card number can be tokenized by utilizing a tokenization algorithm that replaces a primary card number with a unique alternate number, or a token. The token can comprise a randomized string in place of a primary card number. Tokenization can also involve generating an expiration date and/or a security code that is different from an expiration date or security associated with the primary card number of a given card.

A user account can be associated with multiple payment cards, so the payment card data 132 can comprise information about the multiple cards. A user account can be associated with multiple cards that have different card numbers, different card benefits, rewards programs, and other features. Some payment cards attached to a user account might be for personal use, while others can be for business or commercial use. Accordingly, users might have different cards to use in different purchasing scenarios based upon whether a purchase is a personal or business purchase, the rewards that the user desires to receive for a given purchase, discount offers that might differ depending upon the card being used, etc.

Profile data 141 can comprise a user's name, address, phone number, email address, social media profile data, location, travel profile, spending habit data, spending history data and other profile information that can be stored about a user. Profile data 141 can be utilized by the card issuer application 111 to confirm transactions that are attempted by a card user, particularly in an electronic commerce setting. For example, a merchant site or application attempting to obtain payment for a transaction using a user's payment card might be required to present the card number, security code, expiration date, as well as other user information, such as a mailing address, ZIP code, or phone number, to a card issuer before the card issuer will approve and process the transaction.

The client device 102 is representative of a plurality of client devices that can be coupled to the network 109. The client device 102 can include a processor-based system such as a computer system. Such a computer system can be embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), a videogame console, a wearable device, such as a smart watch, a tracking device that facilitate location tracking capabilities, or other devices with like capability. The client device 102 can include one or more displays 167, such as liquid crystal displays (LCDs), gas plasma-based flat panel displays, organic light emitting diode (OLED) displays, etc.

The client device 102 can be configured to execute various applications such as shopping application 150 or other applications. The shopping application 150 can be executed in a client device 102 to access network content served up by the computing environment 103 thereby rendering a user interface on the display. To this end, the shopping application 150 can utilize web view components libraries that can be bundled into the application or provided by an operating system to render web pages within the application. For example, the shopping application 150 can display a link to a third-party site, such as a merchant site, that is rendered within the shopping application 150 by a browser or web view component, and the user interface can include a network page, an application screen, or other user mechanism for obtaining user input.

The shopping application 150 can also allow users various functionality to facilitate management of user accounts, viewing and paying bills, managing authorized users on an account, viewing shopping offers, receiving account alerts, obtaining customer service, and performing other tasks related to a user account.

The shopping application 150 can comprise a curated application provided by a card issuer in which users can learn about offers, benefits, and other information associated with a payment card offered by a card issuer. The content presented within the shopping application 150 can be promoted by the card issuer and brands with which a card issuer is partnered. The branded content presented within the shopping application 150 can comprise video, imagery, and other content in a curated and multimedia experience. Users interacting with the branded content can follow links that lead to a brand's website, where the user can learn about a brand and purchase products offered by the brand.

Because the shopping application 150 can be curated by a card issuer, the user can authenticate with the card issuer application 111 using his or her credentials that are linked to one or more payment cards issued by the card issuer to the user. By authenticating with the card issuer application 111, the user can utilize one or more payment cards to purchase products offered by brands in transactions made within the shopping application 150.

The shopping application 150 can authenticate a user with the card issuer application 111 so that the payment cards associated with a user account can be utilized for transactions with a merchant computing environment 106. Accordingly, once authenticated, the shopping application 150 can allow the user to utilize a payment card issued by the card issuer in checkout user interface elements that are provided by a brand or merchant website without having to remember or enter the card number, security code, expiration date, billing address, shipping address, or other user information. Additionally, for cardholder protection, the shopping application 150 can generate a tokenized form of a payment card of the user and insert the tokenized form of the payment card into a checkout user interface element. The tokenized form of the card can represent a unique token or number that is generated by the shopping application 150 or requested by the shopping application 150 from the card issuer application 111 that can be inserted into a checkout user interface in the place of the actual card number associated with a payment card of the user.

The shopping application 150 can recognize a checkout user interface provided by the merchant computing environment 106 to the shopping application 150 within a web view component on the shopping application 150 by recognizing checkout form elements in the markup language that is rendered by the shopping application 150 within a user interface. The checkout form elements can be recognized based upon metadata embedded within the markup language of a checkout form or checkout page. The shopping application 150 can allow the user to select a payment card associated with the user account for a given transaction or to select a default payment card to use for transactions.

In some examples, the shopping application 150 can also determine whether other payment cards associated with a user account of a currently logged in user might be more beneficial than others for use in a transaction with the merchant computing environment 106. For example, if an alternative payment card would result in more beneficial purchasing terms for the user, such as improved credit card rewards, a discount from the merchant, or other purchasing terms, the shopping application 150 can generate a suggestion to use an alternative payment card on the user's account and present the suggestion in a user interface element within the shopping application 150.

By automatically utilizing tokens associated with a payment card of the user, the user's actual payment card details can be obfuscated from a given merchant operating a given merchant computing environment 106 without requiring the user to generate and insert a virtual card number, which can be a manual and cumbersome process.

The merchant computing environment 106 can include one or more computing devices that include a processor, a memory, and/or a network interface. For example, the computing devices can be configured to perform computations on behalf of other computing devices or applications. As another example, such computing devices can host and/or provide content to other computing devices in response to requests for content.

Moreover, the merchant computing environment 106 can employ a plurality of computing devices that can be arranged in one or more server banks or computer banks or other arrangements. Such computing devices can be located in a single installation or can be distributed among many different geographical locations. For example, the merchant computing environment 106 can include a plurality of computing devices that together can include a hosted computing resource, a grid computing resource or any other distributed computing arrangement. In some cases, the merchant computing environment 106 can correspond to an elastic computing resource where the allotted capacity of processing, network, storage, or other computing-related resources can vary over time.

The merchant computing environment 106 can provide content, such as a website associated with a brand or a merchant, that can be rendered by a shopping application 150 within a web view or browser component. The content can comprise educational, promotional, or inspirational content. The content can also comprise an electronic commerce site of the brand through which users can learn about products offered by a brand as well as purchase items offered by the brand. The content can be promoted within the shopping application 150.

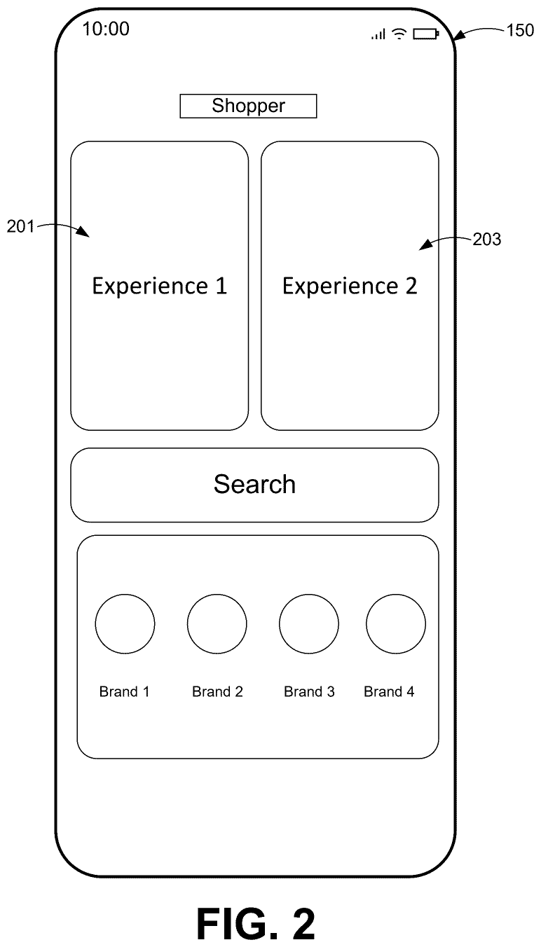

FIG. 2 illustrates an example user interface of the shopping application 150 according to one example. As noted above, the shopping application 150 can provide a brand discovery and shopping experience that is curated by a payment card issuer or other entity. The shopping application 150 can provide a trusted platform in which the user can authenticate his or her credentials with the card issuer application 111 and shop various brands. For example, a card issuer can secure partnerships with brands that permit the brands to present product discovery content, such as within merchant experience user interface elements 201 and 203.

By authenticating with the card issuer application 111 via the shopping application 150, a user can utilize payment cards issued by the card issuer that are associated with the user account of the user. The shopping application 150 can allow the user to utilize one or more payment cards issued by the card issuer to make purchases within the shopping application 150. In one example, transactions to make purchases can be made with a payment card associated with the user account without requiring the user to enter the card details in a checkout user interface.

In the example of FIG. 2, the shopping application 150 can display content on behalf of brands with which the user can interact. For example, the user can follow or interact with merchant experience user interface element 201, which can cause the shopping application 150 to generate a web view or browser component that renders content provided by a merchant computing environment 106. The content can comprise pages served by a merchant website.

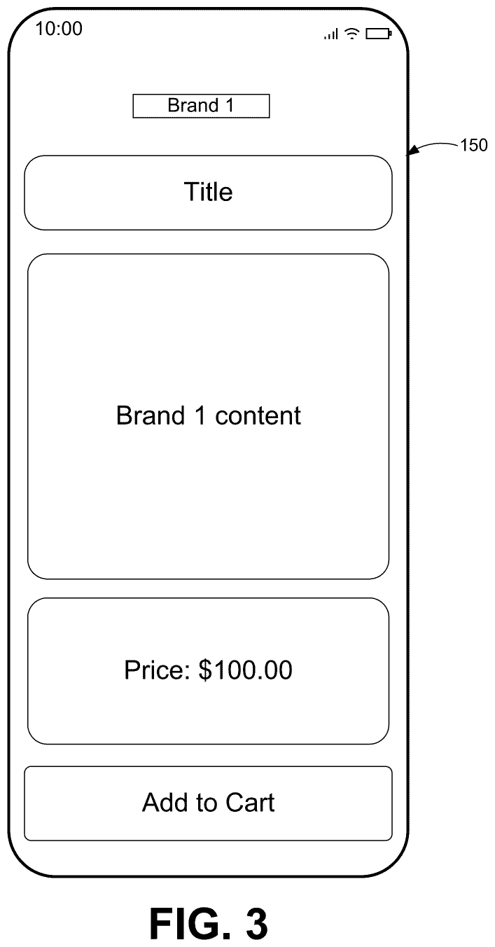

Continuing the example of FIG. 2, reference is made to FIG. 3, which shows the shopping application 150 rendering content in a web view component. The content rendered in the web view component is content obtained from a merchant website, or the merchant computing environment 106. The content can comprise product information regarding products offered by a brand that has partnered with the card issuer to show content within the shopping application 150. By allowing brands to direct users to a website of the brand within the shopping application 150, the card issuer can promote brand content to users without having to directly curate the content itself. In other words, the merchant experience user interface element 201 can comprise a link to the brand website, which can be rendered within the shopping application 150.

In the example of FIG. 3, a user can discover or learn about products offered by the brand by navigating a website of the brand within the shopping application 150. The content can comprise product information, pricing, and also include the ability for a user to purchase products from the merchant or brand website within the shopping application 150. As shown in FIG. 3, the user can add products to a virtual shopping cart.

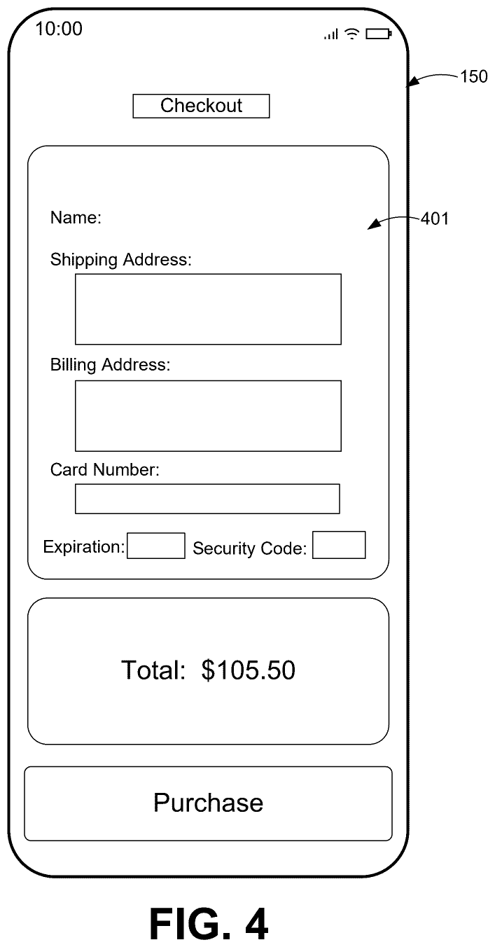

Continuing the example of FIG. 3, reference is made to FIG. 4, which shows the shopping application 150 rendering content in a web view component. The content rendered in the web view component is content obtained from a merchant website, or the merchant computing environment 106. The content can comprise product information regarding products offered by a brand that has partnered with the card issuer to show content within the shopping application 150. By allowing brands to direct users to a website of the brand within the shopping application 150, the card issuer can promote brand content to users without having to directly curate the content itself. In other words, the merchant experience user interface element 201 can comprise a link to the brand website, which can be rendered within the shopping application 150.

In the example of FIG. 3, a user can discover or learn about products offered by the brand by navigating a website of the brand within the shopping application 150. The content can comprise product information, pricing, and also include the ability for a user to purchase products from the merchant or brand website within the shopping application 150. As shown in FIG. 3, the user can add products to a virtual shopping cart.

Continuing the example of FIG. 3, reference is now made to FIG. 4. FIG. 4 illustrates an example of how a merchant or brand website can provide a checkout user interface element 401 that can be rendered by the shopping application 150 on a client device 102. In the depicted user interface, the shopping application 150 can render the checkout user interface element 401 using a web view component within the shopping application 150. The user interface can comprise markup language, such as a mobile web page, that is retrieved from the merchant computing environment 106 by the shopping application 150.

The shopping application 150 can detect that the checkout user interface element 401 contains one or more fields in which user information obtained from the card issuer application 111 can be inserted to facilitate a transaction with the merchant or brand. The shopping application 150 can detect the checkout user interface element 401 and fields within the checkout user interface element 401 by detecting form elements that correspond to a name, billing address, shipping address, payment card number, card security code, and/or expiration date.

Upon detection of a checkout user interface element 401, the shopping application 150 can automatically and without user intervention populate the fields of the checkout user interface element 401 with the information associated with a user account. The information associated with a user account can be retrieved from the card issuer application 111 by the shopping application 150. In some cases, the information associated with the user account can be stored or cached on the client device 102 by the shopping application 150.

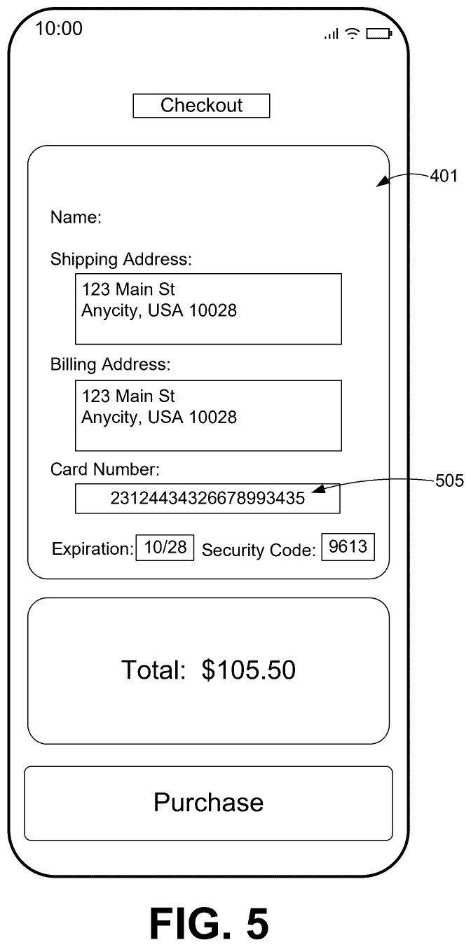

Continuing the example of FIG. 4, reference is now made to FIG. 5, which illustrates how the shopping application 150 can populate the checkout user interface element 401 with information retrieved from a user account of the user. The information populated within the checkout user interface element 401 can comprise a user's name, billing address, shipping address, payment card number, expiration date, and/or security. The information populated within the checkout user interface element 401 can be obtained from the card issuer application 111.

In some examples, the shopping application 150 can generate a tokenized form of the user's payment card number, or a token 505, and insert the token 505 into the checkout user interface element 401 as the card number. The token 505 can comprise a one-time-use card number that a card issuer can issue and that corresponds a primary payment card number. The token 505 can comprise a unique number, or a number that is different from, the primary payment card number to protect the security of the payment card number. By inserting the token 505 into the checkout user interface element 401 on behalf of the user the shopping application 150 can facilitate a transaction with a merchant website on behalf of the user.

In some examples, the shopping application 150 can facilitate a transaction by performing a checkout flow by inserting a token 505 into a third-party digital payment service checkout form, such as a checkout form powered by a third-party service like Paypal™, Google Pay™, Apple Pay™, etc.

In some examples, the token 505 can be obtained from the card issuer application 111 by the shopping application 150. The card issuer application 111 can impose spending controls on the token 505 so that a token-specific spending limit can apply that is less than a spending limit associated with a payment card to which the token 505 corresponds. In some examples, the shopping application 150 can transmit a request to generate the token 505 to the card issuer application 111 along with an identifier that identifies the merchant or brand associated with a checkout user interface element 401. In this scenario, the card issuer application 111 can generate a token 505 that can only be used for transactions with a site specific to the identified merchant or brand. Attempts to use the token 505 at any other sites can result in a payment processor declining the transaction.

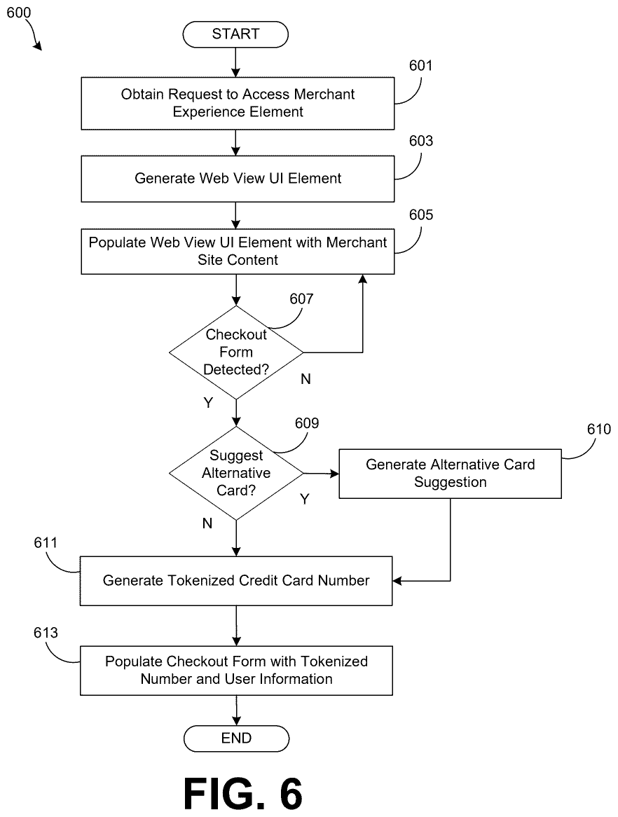

FIG. 6 illustrates a flowchart 600 that provides an example of the operation of the components of the network environment 100. It is understood that the flowchart of FIG. 6 provides merely an example of the many different types of functional arrangements that can be employed to implement the operation of the depicted portion of the network environment 100. As an alternative, the flowchart of FIG. 6 can be viewed as depicting an example of elements of a method implemented within the network environment 100. In particular, the flowchart of FIG. 6 depicts the how the shopping application 150 can be utilized to facilitate transactions with a merchant computing environment 106.

First, at block 601, the shopping application 150 can obtain a request to access a merchant experience user interface element 201. The merchant experience user interface element 201 can comprise a link or other element within the shopping application 150 in which the user can access content associated with a particular brand or merchant that is presenting content within the shopping application 150. At block 603, the shopping application 150 can generate a web view user interface element, or a web view component. The web view component can render content provided by a merchant computing environment 106, such as content or pages from a merchant website. The content within the web view component is rendered within the shopping application 150 so that the shopping application 150 can analyze the user interface elements presented within the content to facilitate transactions on behalf of the user.

At block 605, the shopping application 150 can populate the web view component with content obtained from the merchant computing environment 106, or a merchant site. As noted above, the content can comprise markup language obtained from the merchant computing environment 106 that can contain promotional content corresponding to the brand or merchant.

At block 607, the shopping application 150 can determine whether a checkout user interface element 401 is detected within the web view component. For example, the shopping application 150 could evaluate the web view component for hypertext markup language (HTML) code indicating the presents of a checkout user interface element 401 (e.g., due to the presence of known e-commerce application libraries or user interface elements within the web view component). If no checkout user interface element 401, the process can return to block 605, where the shopping application 150 can continue to render content within the web view component that is obtained from the merchant computing environment 106. If the shopping application 150 detects a checkout user interface element 401 within the content rendered in the web view component, the process can proceed to block 609.

At block 609, the shopping application 150 can determine, based upon an identity of the merchant or brand associated with the merchant experience user interface element 201, whether a more beneficial payment card other than a default payment card associated with the user account, would result in more beneficial purchasing terms. For example, if an alternative payment card would result in more beneficial purchasing terms for the user, such as improved credit card rewards, a discount from the merchant, or other purchasing terms, the shopping application 150 can generate a suggestion to use an alternative payment card on the user's account and present the suggestion in a user interface element within the shopping application 150.

The shopping application 150 could make this determination in a number of ways. For example, the shopping application 150 could search a list of offers associated with individual ones of the payment cards to determine if any of the offers matched the merchant or the transaction. For instance, one payment card could have a 10% discount associated with it for the merchant. In another instance, a separate payment card could have an offer of 15% off purchases with a specific category of merchant or retailer (e.g., electronics, clothing, health and beauty, etc.). Similarly, a payment card could have an increased rewards rate for certain types of purchases (e.g., double rewards points when making travel purchases). If multiple cards are associated with applicable offers, or an individual payment card has multiple offers associated with it, then the shopping application 150 could choose the payment card associated with an offer that would provide the largest discount.

If the shopping application 150 determines to generate an alternative card suggestion, the process can proceed to block 610, where the shopping application 150 generates the suggestion. The alternative card suggestion can be generated by displaying a user interface element within the shopping application 150 or by automatically selecting an alternative card without user intervention.

From block 610 the process can then proceed to block 611. The process can also proceed to block 611 from block 609 if the shopping application 150 does not determine that an alternative card recommendation should be made. At block 611, the shopping application 150 can generate a tokenized form of the payment card that is being used in the transaction with the merchant computing environment 106. A card number can be tokenized by utilizing a tokenization algorithm that replaces a primary card number with a unique alternate number, or a token 505. Tokenization can also involve generating an expiration date and/or a security code that is different from an expiration date or security associated with the primary card number of a given card.

At block 613, the shopping application 150 can populate the checkout user interface element 401 with the token 505 in addition to user information requested in the checkout user interface element 401 without user intervention, thereby facilitating a transaction with the merchant computing environment 106 on behalf of the user.

Thereafter, this portion of the process proceeds to completion.

A number of software components previously discussed are stored in the memory of the respective computing devices and are executable by the processor of the respective computing devices. In this respect, the term “executable” means a program file that is in a form that can ultimately be run by the processor. Examples of executable programs can be a compiled program that can be translated into machine code in a format that can be loaded into a random-access portion of the memory and run by the processor, source code that can be expressed in proper format such as object code that is capable of being loaded into a random-access portion of the memory and executed by the processor, or source code that can be interpreted by another executable program to generate instructions in a random-access portion of the memory to be executed by the processor. An executable program can be stored in any portion or component of the memory, including random-access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random-access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random-access memory (SRAM), dynamic random-access memory (DRAM), or magnetic random-access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts show the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the flowcharts show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the sequence diagrams can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g., storage area networks or distributed or clustered filesystems or databases) may also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random-access memory (RAM) including static random-access memory (SRAM) and dynamic random-access memory (DRAM), or magnetic random-access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same computing environment 103,106.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

Therefore, the following is claimed:

1. A system, comprising:
a computing device comprising a processor and a memory; and
an application stored in the memory that, when executed by the processor, causes the computing device to at least:
in response to an interaction with a user interface element for the application, wherein the user interface element corresponds to a merchant experience, generate a web view user interface (UI) element in the application;
render a merchant specific page within the web view UI element;
detect a checkout user interface element in the merchant specific page;
tokenize a payment card associated with the user account in response to detecting the checkout user interface element;
retrieve user information associated with the user account, the user information comprising at least one of: a shipping address, a name, or a phone number; and
populate the checkout user interface element with the user information and the tokenized form of the payment card.

2. The system of claim 1, wherein the payment card is tokenized by generating a randomized string that is associated with the payment card, wherein the randomized string is submitted to a merchant payment portal instead of a payment card number.

3. The system of claim 1, wherein the application tokenizes the payment card by causing the computing device to at least:
transmit a request to a card issuer system for a token corresponding to a payment card, the request comprising an identifier corresponding to merchant associated with merchant specific page; and
obtain the token from the card issuer system, wherein the token can only be used for transactions with the merchant.

4. The system of claim 1, wherein the application tokenizes the payment card by causing the computing device to at least:
obtain a token corresponding to the payment card, wherein the token is associated with a spending limit that is less than a respective spending limit of the payment card.

5. The system of claim 1, wherein the application populates the checkout user interface element with the tokenized form of the payment card and the user information without user interaction.

6. The system of claim 1, wherein the application further causes the computing device to generate a recommendation for an alternative payment card associated with the user account for the checkout user interface element.

7. The system of claim 6, wherein the recommendation is based at least in part upon a merchant-specific reward associated with the alternative payment card.

8. A method, comprising:
in response to an interaction with a user interface element, wherein the user interface element corresponds to a merchant experience, generating a web view user interface (UI) element;
rendering a merchant specific page within the web view UI element;
detecting a checkout user interface element in the merchant specific page;
tokenizing a payment card associated with the user account in response to detecting the checkout user interface element;
retrieving user information associated with the user account, the user information comprising at least one of: a shipping address, a name, or a phone number; and
populating the checkout user interface element with the user information and the tokenized form of the payment card.

9. The method of claim 8, wherein the payment card is tokenized by generating a randomized string that is associated with the payment card, wherein the randomized string is submitted to a merchant payment portal instead of a payment card number.

10. The method of claim 8, wherein tokenizing the payment card further comprises:
transmitting a request to a card issuer system for a token corresponding to a payment card, the request comprising an identifier corresponding to merchant associated with merchant specific page; and
obtaining the token from the card issuer system, wherein the token can only be used for transactions with the merchant.

11. The method of claim 8, wherein tokenizing the payment card further comprises:
obtaining a token corresponding to the payment card, wherein the token is associated with a spending limit that is less than a respective spending limit of the payment card.

12. The method of claim 10, further comprising populating the checkout user interface element with the tokenized form of the payment card and the user information without user interaction.

13. The method of claim 8, further comprising generating a recommendation for an alternative payment card associated with the user account for the checkout user interface element.

14. The method of claim 13, wherein the recommendation is based at least in part upon a merchant-specific reward associated with the alternative payment card.

15. A non-transitory, computer-readable medium, comprising machine-readable instructions that, when executed by a processor of a computing device, cause the computing device to at least:
in response to an interaction with a user interface element for an application, wherein the user interface element corresponds to a merchant experience, generate a web view user interface (UI) element in the application;
render a merchant specific page within the web view UI element;
detect a checkout user interface element in the merchant specific page;
tokenize a payment card associated with the user account in response to detecting the checkout user interface element;
retrieve user information associated with the user account, the user information comprising at least one of: a shipping address, a name, or a phone number; and
populate the checkout user interface element with the user information and the tokenized form of the payment card.

16. The non-transitory, computer-readable medium of claim 15, wherein the payment card is tokenized by generating a randomized string that is associated with the payment card, wherein the randomized string is submitted to a merchant payment portal instead of a payment card number.

17. The non-transitory, computer-readable medium of claim 15, wherein the machine-readable instructions tokenize the payment card by causing the computing device to at least:
transmit a request to a card issuer system for a token corresponding to a payment card, the request comprising an identifier corresponding to merchant associated with merchant specific page; and
obtain the token from the card issuer system, wherein the token can only be used for transactions with the merchant.

18. The non-transitory, computer-readable medium of claim 15, wherein the machine-readable instructions tokenize the payment card by causing the computing device to at least:
obtain a token corresponding to the payment card, wherein the token is associated with a spending limit that is less than a respective spending limit of the payment card.

19. The non-transitory, computer-readable medium of claim 17, wherein the machine-readable instructions populate the checkout user interface element with the tokenized form of the payment card and the user information without user interaction.

20. The non-transitory, computer-readable medium of claim 15, wherein the machine-readable instructions further cause the computing device to generate a recommendation for an alternative payment card associated with the user account for the checkout user interface element.
